(19) United States
(12) Patent Application Publication
(10) Pub. No.: US 2006/0218260 A1
(43) Pub. Date: Sep. 28, 2006

(54) Device and method for network information accessing

(75) Inventors: Yuan-Te Hsieh, Tainan County (TW); Chiang-Ho Tseng, Taipei City (TW); Roger Wei, Hsinchu City (TW); Tzu Houg Chang, Hsinchu City (TW)

Correspondence Address: BIRCH STEWART KOLASCH & BIRCH, PO BOX 747, FALLS CHURCH, VA, 22040-0747, US

(73) Assignee: Arcadyan Technology Corporation

(21) Appl. No.: 11/087,659

(22) Filed: Mar. 24, 2005

(51) Int. Cl. G06F 15/173

(52) U.S. Cl. 709/223

(57) ABSTRACT

A network information access device is used for transferring information with an electronic device. The network information access device includes a memory unit, a receiving unit, a selecting unit, and a broadcast unit. The memory unit stores a plurality of Internet protocol information. The receiving unit receives a search signal from the electronic device. The selecting unit selects at least one of the Internet protocol information from the memory unit according to the search signal. The broadcast unit delivers the selected Internet protocol information to the electronic device.

### BACKGROUND OF THE INVENTION

1. Field of Invention

The invention relates to a device and a method for network information accessing and, in particular, to a device and a method for network information accessing, which can automatically detect the setting information.

2. Related Art

Due to the network industry is fast developed recently, the various kinds of information around the world are quickly spread, which blossoms our daily lives. People can deliver/receive e-mails, transfer files, and achieve the applications of electronic bulletin board and remote accessing. Not only the work styles of governments and businesses are affected, but also activities of humans are changed.

For connecting to the network with a computer, many peripheral equipments, such as a network card, a modem and the likes, are necessary. Besides, the most confusing problem of the user is that he/she should setup many configurations to make the network information access device and computer be located in the same local area network. Accordingly, the computer can connect to the network. For example, during applying an ADSL, there are many setup procedures such as the user account, password, IP address, DNS configuration before the computer can connect to the network. The user not only must know all of the setup procedures, but also should memory all setup contents for normally connecting to network with the computer. This is very inconvenient for the users and the manufactures.

In addition, accompanying with the progress of the wireless technology, the manufactures invent many wireless network information access devices such as the wireless IP sharing devices. However, the environment conditions for the wireless transmission make the encryption setting more complex, and the user must memory the password(s). Thus, many users may use the wireless network information access devices without setting encryptions, resulting in that the information is easily grabbed. When the someone hacks in user's computer, the computer is almost unfortified and the security of the computer is threatened. Therefore, in the wireless environment, the security setup is one of the most important considerations.

As mentioned above, regarding to the wider and wider strata and ages of users, it is an important subject to allow every one browsing the network world easily, and to increase the security of network information access device for the vigorously developed wireless technology in the future.

### SUMMARY OF THE INVENTION

In view of the foregoing, the invention is to provide a network information access device and a network information access method to simplify the network setting for the user to connect to the network.

To achieve the above, a network information access device for transferring information with an electronic device includes a memory unit, a receiving unit, a selecting unit, and a broadcast unit. The memory unit stores a plurality of Internet protocol information. The receiving unit receives a search signal from the electronic device. The selecting unit selects at least one of the Internet protocol information from the memory unit according to the search signal. The broadcast unit delivers the selected Internet protocol information to the electronic device.

To achieve the above, a network information access method, which cooperates with a network information access device and an electronic device in a local area network, the network information access device stored a plurality of Internet protocol information. The method comprising the following step: the first step, generating a search signal by the electronic device. The second step, receiving the search signal by the network information access device. The third step, delivering the Internet protocol information from the network information access device to the electronic device according to the search signal. And the fourth step, performing the Internet protocol information on the electronic device.

As mentioned above, the network information access device of the invention can immediately deliver the Internet protocol information that is necessary for the electronic device to connect to Internet when receiving the search signal from the electronic device. Thus, the user is free from memorizing the setting procedures and the setting contents.

### BRIEF DESCRIPTION OF THE DRAWINGS

The invention will become more fully understood from the detailed description given herein below illustration only, and thus is not limitative of the present invention, and wherein:

FIG. 1 is a schematic diagram showing a network information access device according to an embodiment of the invention;

FIG. 2 is a flow chart showing a network information access method according to an embodiment of the invention; and

FIGS. 3A and 3B are schematic diagrams showing the data transmission with the network information access device according to the embodiment of the invention.

### DETAILED DESCRIPTION OF THE INVENTION

The present invention will be apparent from the following detailed description, which proceeds with reference to the accompanying drawings, wherein the same references relate to the same elements.

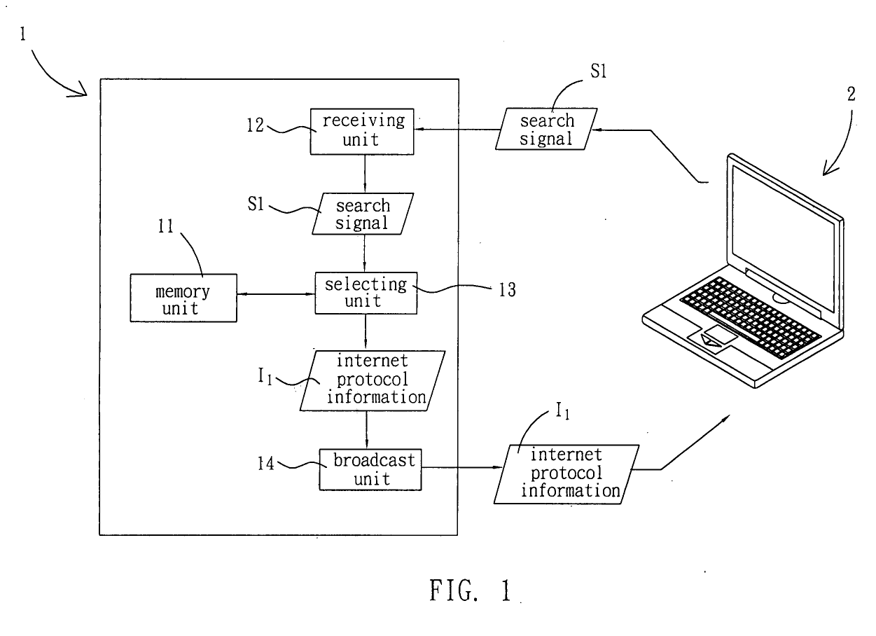

Refer to FIG. 1 illustrating a schematic diagram showing a network information access device according to the embodiment of the invention. A network information access device 1 is used for transferring the information with an electronic device 2 in a local area network (LAN). In the embodiment, the network information access device 1 can be a wire network information access device or a wireless network information access device, such as a Router, a Gateway, or an Access point (AP). In this case, the electronic device 2 can be a computer, a cell phone, or a personal digital assistant (PDA).

The network information access device 1 includes a memory unit 11, a receiving unit 12, a selecting unit 13, and a broadcast unit 14.

The memory unit 11 stores a plurality of Internet protocol information I₁. In the embodiment, the Internet protocol information I₁ may include a MAC address, a device name, an Internet protocol (IP) mask information, a gateway address, a hardware version, an IP address, product type information, or function information.

The receiving unit 12 receives a search signal S1 from the electronic device 2. In this case, the search signal S1 is a search signal. In the embodiment, the search signal S1 is to search the service set identifier (SSID) same to the electronic device 2 and to obtain the network information access device 1 in the same available scope.

The selecting unit 13 selects at least one Internet protocol information I₁ for the electronic device 2 from the memory unit 11 in accordance with the search signal S1.

The broadcast unit 14 delivers the selected Internet protocol information I₁ that selects by the selecting unit 13 to the electronic device 2.

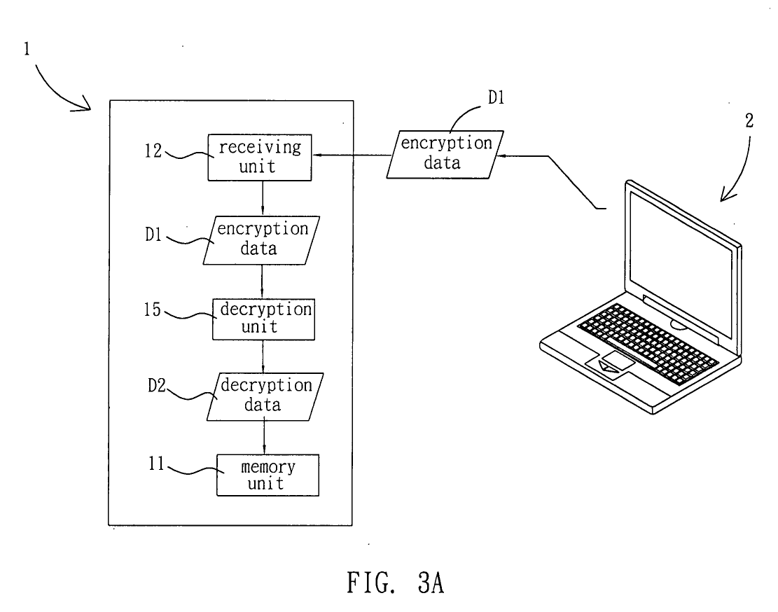

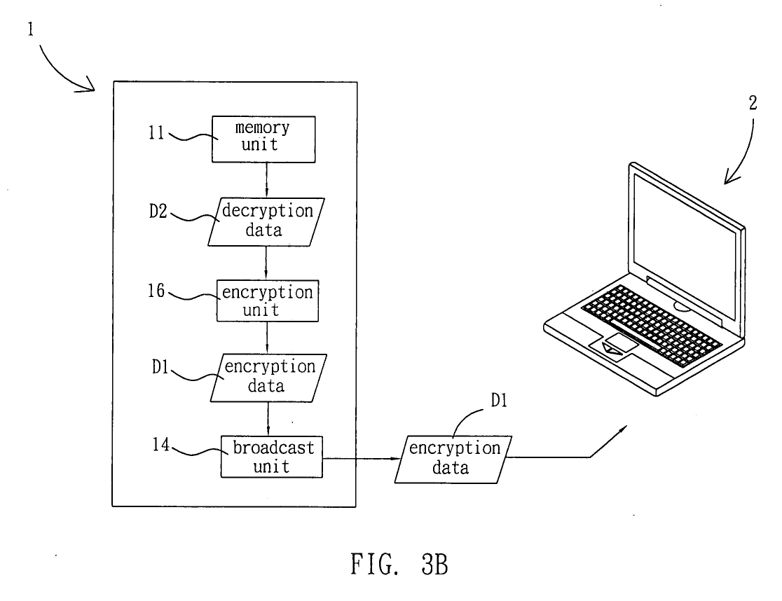

Referring to FIG. 3A and FIG. 3B, the network information access device 1 further includes a decryption unit 15 and an encryption unit 16, which are electrically connected to the receiving unit 12 and the broadcast unit 14, respectively.

In the embodiment, the decryption unit 15 is electrically connected with the receiving unit 12 and the memory unit 11, respectively, which transfers the encrypting data received by the receiving unit 12 to the decrypting data, and delivers the decrypting data into the memory unit 11; the encryption unit 16 is electrically connected with the memory unit 11 and the broadcast unit 14, respectively, which transfers the decrypting data stored in the memory unit 11 to the encrypting data, and delivers to the broadcast unit 14.

In the embodiment, the decryption unit 15 and the encryption unit 16 decrypt/encrypt the data, which are delivered between the electronic device 2 and the network information access device 1 with utilizing the RC4 or AES technology. In this case, the data so-called can be text data, figure data, or video/audio data.

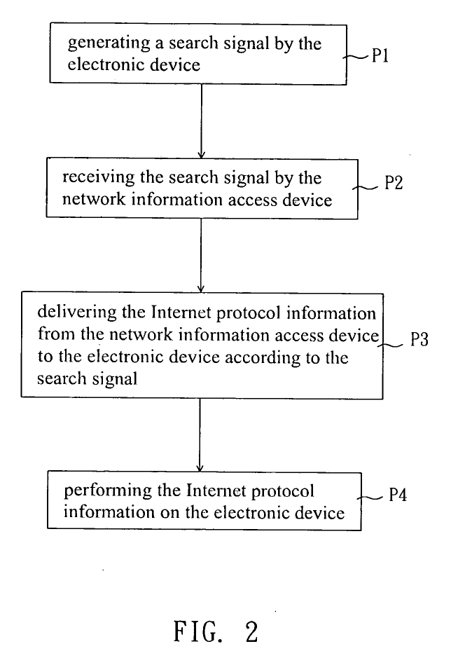

Hereinafter, referring to FIG. 2 and collocating above mentioned, for illustrating a network information access method according to the embodiment of the invention.

The method cooperates with the network information access device 1 and the electronic device 2 in a local area network, and the network information access device stores a plurality of Internet protocol information. In the embodiment, the network information access device 1 can be a wire network information access device or a wireless network information access device, such as a Router, a Gateway, or an Access point. In this case, the electronic device 2 can be a computer, a cell phone, or a personal digital assistant.

First, the process P1 is generating a search signal S1 by the electronic device 2 to search the service set identifier (SSID) same to the electronic device 2 and to obtain the network information access device 1 in the same available scope.

Next, the process P2 is receiving the search signal S1 by the network information access device. In the embodiment, the search signal S1 is received by the receiving unit 12 of the network information access device 1.

After that, the process P3 is delivering the Internet protocol information I₁ to the electronic device 2. In the embodiment, the broadcast unit 14 of the network information access device 1 delivers the selected Internet protocol information I₁ to the electronic device 2. Accordingly, the Internet protocol information I₁ may include the device name, the media access control address (MAC address), the IP address, the IP mask information, the gateway address, the hardware version, the firmware version, the product type, or the function information. Herein, the function information may include the function information of encrypting/decrypting data.

In the embodiment, the network information access devices, which have the different models or functions, may be searched by the electronic device 2 in the available scope. Hence, the process P4, the electronic device 2 will select the network information access device 1, which is applicable with the electronic device 2 and will obtain the Internet protocol information I₁. And then, the setup of the Internet protocol information I₁ on the electronic device 2 can be automatically performed.

Regarding to the above-mentioned process, the electronic device 2 do not need to research the network information access device 1 when moving in the same local area network, because the Internet protocol information I₁ is already performed on the electronic device 2. To be noted, the electronic device 2 need to repeat the above-mentioned process to search and setup again when the electronic device 2 moving to the other local area network.

In the embodiment, the data can be transferred between the electronic device 2 and the network information access device 1 after finishing the setup of the Internet protocol information I₁. In this case, the data so-called can be text data, figure data, or video/audio data. Referring to FIG. 3A, for achieving the safe transmission, the electronic device 2 can transform the data to be delivered from the electronic device 2 to the network information access device 1 into encryption data D1 with utilizing the RC4 or AES technology. After the receiving unit 12 receives the encryption data D1, the encryption data D1 is delivered to the decryption unit 15, and then decrypted by the decryption unit 15 to generate decryption data D2. After that, the decryption unit 15 delivers the decryption data D2 to the memory unit 11.

Referring to FIG. 3B, for delivering the data from network information access device 1 to the electronic device 2, the decryption data D2 is firstly delivered to the encryption unit 16 from the memory unit 11. Then, the encryption unit 16 encrypts the decryption data D2 to the encryption data D1 with utilizing the RC4 or AES technology. After that, the encryption data D1 are delivered from the encryption unit 16 to the broadcast unit 14, and then are delivered to the electronic device 2 by the broadcast unit 14.

As mention above, the network information access device of the invention utilizes the selecting unit to deliver the Internet protocol information that the electronic device needs after the network information access device received the search signal issued by the electronic device from the memory unit to the electronic device by the broadcast unit. The setup of the Internet protocol information on the electronic device can be automatically performed by the program installed in the electronic device. Accordingly, the electronic device can normally use the network function. Comparing to the conventional method, that the user need to know the setting procedures and setting contents, the network information access device of the invention can save many setting procedures for the user.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A network information access device for transferring information with an electronic device in a local area network, comprising:
a memory unit, which stores a plurality of Internet protocol information;
a receiving unit, which receives a search signal from the electronic device;
a selecting unit, which selects at least one of the Internet protocol information from the memory unit in accordance with the search signal; and
a broadcast unit, which delivers the selected the Internet protocol information to the electronic device.

2. The device according to claim 1, wherein the network information access device is a wire network information access device.

3. The device according to claim 1, wherein the network information access device is a wireless network information access device.

4. The device according to claim 1, wherein the network information access device is one of a router, a gateway, and an access point (AP).

5. The device according to claim 1, further comprising:
an encryption/decryption unit, which electrically connects with the receiving unit and the broadcast unit, respectively, and encrypts/decrypts a plurality of text data, figure data, and video/audio data transferred between the electronic device and the network information access device.

6. The device according to claim 5, wherein the encryption/decryption unit encrypts/decrypts the data with utilizing one of a RC4 technology and an AES technology.

7. The device according to claim 1, wherein the Internet protocol information comprise at least one of a device name, an Internet protocol (IP) mask information, a gateway address, a hardware version, an IP address, a product type information, and a capability information.

8. The device according to claim 1, wherein the search signal is to search the service set identifier (SSID) same to the electronic device and to obtain the network information access device in the same available scope.

9. A network information access system, comprising:
a electronic device, which generates a search signal; and
a network information access device, which comprises:
a memory unit, which stores a plurality of Internet protocol information,
a receiving unit, which receives the search signal from the electronic device,
a selecting unit, which selects at least one of the Internet protocol information from the memory unit in accordance with the search signal, and
a broadcast unit, which delivers the selected the Internet protocol information to the electronic device.

10. The system according to claim 9, wherein the network information access device is a wire network information access device.

11. The system according to claim 9, wherein the network information access device is a wireless network information access device.

12. The system according to claim 9, wherein the network information access device is one of a router, a gateway, and an access point (AP).

13. The system according to claim 9, wherein the network information access device further comprises:
an encryption/decryption unit, which electrically connects with the receiving unit and the broadcast unit, respectively, and encrypts/decrypts a plurality of text data, figure data, and video/audio data transferred between the electronic device and the network information access device.

14. The system according to claim 13, wherein the encryption/decryption unit encrypts/decrypts the data with utilizing one of a RC4 technology and an AES technology.

15. The system according to claim 9, wherein the Internet protocol information comprises at least one of a device name, an IP mask information, a gateway address, a hardware version, an Internet protocol address, a product type information, and a capability information.

16. The system according to claim 9, wherein the electronic device is one of a computer, a personal digital assistant (PDA), and a cell phone.

17. The system according to claim 9, wherein the search signal is to search the service set identifier same to the electronic device and to obtain the network information access device in the same available scope.

18. A network information access method, which cooperates with a network information access device and an electronic device in a local area network, the network information access device stored a plurality of Internet protocol information, comprising:
generating a search signal by the electronic device;
receiving the search signal by the network information access device;
delivering the Internet protocol information from the network information access device to the electronic device according to the search signal; and
performing the Internet protocol information on the electronic device.

19. The method according to claim 18, further comprising:
delivering a plurality of text data, figure data, and video/audio data between the electronic device and the network information access device.

20. The method according to claim 19, further comprising:
decrypting the text data, figure data, and video/audio data received by the network information access device.

21. The method according to claim 19, further comprising:
encrypting the text data, figure data, and video/audio data which will deliver to the electronic device.

22. The method according to claim 18, wherein the network information access device is a wire network information access device.

23. The method according to claim 18, wherein the network information access device is a wireless network information access device.

24. The method according to claim 18, wherein the network information access device is one of a router, a gateway, and an access point.

25. The method according to claim 18, wherein the Internet protocol information comprises at least one of a device name, an IP mask information, a gateway address, a hardware version, an Internet protocol address, a product type information, and a capability information.

26. The method according to claim 18, wherein the electronic device is one of a computer, a personal digital assistant, and a cell phone.

27. The method according to claim 18, wherein the search signal is to search the service set identifier same to the electronic device and to obtain the network information access device in the same available scope.
